(19) United States
(12) Patent Application Publication
(10) Pub. No.: US 2004/0051938 A1
(43) Pub. Date: Mar. 18, 2004

(54) Gain controlled optical amplifier

(76) Inventors: Les Yu Chung Chan, Kanata (CA); Piotr Myslinski, Gloucester (CA); Michael Alievsky, Kanata (CA); Czeslaw Szubert, Ottawa (CA); Thomas Peter Taylor, Stittsville (CA)

Correspondence Address: Stephen R. Whitt, 1215 Tottenham Court, Reston, VA, 20194, US

(21) Appl. No.: 10/243,774

(22) Filed: Sep. 16, 2002

(51) Int. Cl. H01S 3/00

(52) U.S. Cl. 359/337.1

(57) ABSTRACT

Gain for single and multi-stage optical amplifiers is controlled to determine gain profile and adjust for input signal transients by varying the gain linearly in relation to balanced variable gain settings in input signal and output signal feedback circuits. ASE correction may be dynamically applied in relation to temperature, input signal level, and gain setting. Feed-forward transient control may also be applied.

### FIELD OF THE INVENTION

The present invention relates to optical communication systems. More particularly, the present invention relates to a gain control system and method for optical amplifiers used in optical communication systems.

### BACKGROUND OF THE INVENTION

Contemporary optical communication systems typically transmit a plurality of optical signals via a single optical fiber. This practice of combining multiple “channels,” each channel being formed by an optical signal having a unique wavelength, is referred to as Wavelength Division Multiplexing (WDM). These WDM optical communication systems are routinely implemented using rare-earth doped fiber optical amplifiers. In particular, Erbium doped fiber amplifiers (EDFAs) are most commonly used optical amplification devices used to amplify optical signals weakened by the inevitable attenuation associated with transmission through an optical communication system.

Optical fiber amplifiers can provide low noise and high gain for optical signals, but suffer from a number of well understood limitations including gain tilt and adverse performance in response to input signal transients.

Gain tilt is the measure of the slope of the wavelength dependent gain across the amplification spectrum of the optical amplifier. It arises because the gain of an optical amplifier is inherently dependent upon the absorption and emission wavelength spectrum of the Erbium ions in the doped fiber. One effect of gain tilt on an optical signal being amplified is a change in output power distribution among WDM channels with any input power variation of the optical signal. As a result of gain tilt, an optical amplifier will not provide uniform gain across the range of channels in a WDM optical communication system.

Previous attempts to remedy the effects of gain tilt prescribe the use of dielectric filter elements within the structure of the optical amplifier. However, such an approach is fixed in relation to a specific gain setting of the amplifier and to specific input power conditions both for input power and wavelength pattern. The fact that different gain settings require different filter elements, and perhaps even different designs, complicates the manufacture of the optical amplifier and stresses related inventory issues.

Gain transient response, where large step changes in the amplifier gain are caused by variations in the number of input channels and/or input power, is also a major problem for WDM systems. Gains transients routinely occur when channel(s) are dropped from or added to the WDM system either by calculated channel reconfiguration, or by system failure. In either event, added channels may depress the power of existing channels below receiver sensitivity. Dropped channels may give rise to error events in the surviving channels as a resulting power spike in the surviving channels can surpass the thresholds for non-linear effects. Resulting error bursts are unacceptable to service providers carrying payload traffic over the optical communication system.

Some of these effects can be eliminated if the amplifier gain, and thus the gain spectrum, is controlled independent of the level of the input optical signal. In this way, a constant gain can be maintained regardless of the number of channels present at the optical amplifier input. This requires rapid gain control, as the gain control system must respond to changes in the level of the input optical signal, and/or channel count, without giving rise to large or prolonged gain transient effects. Conventional systems for implementing independent amplifier gain control use automatic gain control (AGC) in the form of opto-electronic or all optical feedback loops.

One example, U.S. Pat. No. 6,163,399, of a conventional gain control system for an optical amplifier is shown in Figure (FIG.) 1. In FIG. 1, an input reference signal is developed by sampling the optical signal input to EDFA 2 using photo-detector 3a. Photo-detector 3a outputs an electrical, input reference signal through trans-impedance (TZ) amplifier 4a, filter 5a and root-mean-square (RMS)-to-DC converter 6a. An output reference signal is similarly developed through optical detector 3b, trans-impedance (TZ) amplifier 4b, filter 5b, and RMS-to-DC converter 6b. The signal paths between photo-detector and an error signal determining means for the input and output reference signals may be referred to respectively as an input arm circuit and an output arm circuit. Such arm circuits form a portion of a control loop and may include additional elements.

In the conventional example shown in FIG. 1, the input reference signal and output reference signal are applied to a divider 7 which yields an estimated gain signal applied to a first input of a comparator 8. The estimated gain signal is also applied to control unit 11 through analog-to-digital (A/D) converter 10. Control unit 11 provides a reference gain signal to a second input of comparator 8 through D/A converter 9. Comparator 8 produces a gain correction signal by subtracting the estimated gain signal from the reference gain signal. The gain correction signal then modifies a nominal gain control signal from control unit 11 in summing circuit 12. The resulting control signal is applied to the pump driver 13 for the EDFA 2.

This conventional approach to optical amplifier gain control succeeds to a limited extent only by performing a division function using non-linear analog circuits. Other conventional approaches to electronic control of optical amplifier gain are achieved by an alternative method of performing a logarithmic function on both input and output reference signals. After converting the input and output reference signal from linear to logarithmic form, they are subtracted, and the result is adjusted and/or applied in relation to a fixed optical gain of the amplifier.

Division and logarithm functions can only be realized by non-linear circuits. It is difficult to design such non-linear circuits to meet both the broad input signal range and high accuracy requirements imposed by contemporary optical communication systems. Accordingly, such functions are typically provided by digital computations performed in a microprocessor or similar logic unit. Unfortunately, microprocessor based implementations require conversion of reference signals from analog to digital form and subsequent conversion of the computational results from digital to analog form before a control signal can be defined for application to a laser pump driver. As a result, the digital approach to control signal definition increases control system complexity. It further results in slower control system response time, since response time is determined by the combination of software execution time, microprocessor signal handling speed, and the time required to perform AID and D/A conversions. Given the practical constraints of microprocessor based implementations, it is extremely difficult to design a gain control system for an optical amplifier having a response time less than several milliseconds.

As WDM systems continue to evolve, they will incorporate an ever increasing number of channels. As WDM system are deployed in metro applications and extended long-haul applications, the frequency and severity of channel add/drops will only increase. Ultimately, the gain control response times offered by conventional approaches must fail.

As noted above, most conventional approaches to gain control for optical amplifiers are static in nature. That is, gain tilt and gain transient suppression are established in relation to a factory-set amplifier gain value based on an estimated operating temperature. Changes in gain value and temperature will obviate much of the conventional effort directed to accommodating changes in the input power level. Previous approaches, such as the one explained in U.S. Pat. No. 6,366,395, herein incorporated by reference, address the matter of temperature compensation, but do so in the context of a single, fixed gain amplifier.

### SUMMARY OF THE INVENTION

The present invention provides a gain control system for an optical amplifier wherein an input reference signal is formed in an input arm circuit and an output reference signal is formed in a corresponding output arm circuit. An input arm circuit is a part of a feedback circuit receiving and acting upon a signal indicative of the power level of the optical signal input into the optical amplifier. Analogously, an output arm circuit is a part of a feedback circuit receiving and acting upon a signal indicative of the power level of the amplified optical signal produced by the optical amplifier. Together the input reference signal derived from the input arm circuit and the output reference signal from the output arm circuit operate within an error circuit to generate an error signal. This error signal is used to form a gain control signal that is applied to the optical amplifier. Typically, a control circuit generate the gain control signal that is applied to as a drive signal to a pump laser through a drive circuit.

In one aspect, the present invention provides an input arm circuit and an output arm circuit formed from linear analog circuits. No division or logarithmic functions are implemented in either feedback arm. The linear analog feedback paths in conjunction with a control unit are able to control the optical amplifier over an acceptably wide range of input signals with excellent accuracy. Indeed, the control system response time for the present invention is measured in microseconds, as compared with response times for conventional systems which are measured in milliseconds.

In a related aspect, the present invention incorporates a gain setting circuit in the input arm circuit, and/or the output arm circuit. Whether the single gain setting circuit is used in the input and/or the output arm circuit, the gain of the optical amplifier will vary directly with the gain electrically established in the gain setting circuit. However, as presently preferred, first and second gain setting circuits are used in the input and output arm circuits respectively. Thus, the optical amplifier gain will vary in accordance with the variable gain settings in each of the first and second gain setting circuits. Further to this point, the optical amplifier gain is preferably established by a fully balanced gain setting between the first and second gain setting circuits.

In another aspect, the present invention provides for dynamic compensation for amplified spontaneous emissions (ASE) within control loop. Where one of the input or output arm circuits incorporates an amplified spontaneous emissions (ASE) correction circuit, the input reference signal and the output reference signal developed by the dual feedback arms will “zero-out” when the gain of the optical amplifier is equal to the desired gain setting G_{EDFA} as established in the gain setting circuits. Stated in other terms;

0=[P_{OUT}*G_{OUT}−P_{ASE}]−(P_{IN}*G_{IN})

where, P_{OUT} is the power of the total optical output by the optical amplifier, P_{ASE} is the value of the ASE correction value calculated by the ASE correction circuit, G_{OUT} is the gain of the second gain setting circuit residing in the output arm circuit, P_{IN} is the power of the optical signal input to the optical amplifier, and G_{IN} is the gain of the first gain setting circuit residing in the input arm circuit.

The present invention thus allows the establishment and maintenance by feedback control of an exact gain value for the optical amplifier using electronic means. Gain is not estimated as in many conventional control systems.

The present invention also provides in a related aspect weighted sum of proportional amplification, integration, and/or differentiation of the error signal during definition of the gain control signal. Unlike, conventional gain control systems the gain of proportional amplification is preferably dynamically changed in relation to changes in the optical input signal level and optical amplifier gain setting. Similarly, integration is adaptively applied (switched IN and OUT) in response to the state of the optical input signal level. The present invention may also provide feed-forward transient control to either the input reference signal or the output reference signal in response to detected changes in the optical input signal level.

In another aspect of the present invention, the input and output reference signals are synchronized in their application to the error circuit, such that these signals have common temporal relevance to the optical input signal. A delay line or similar delay element may be placed in the input arm circuit to achieve this relationship.

A gain control methodology is also set forth by the present invention. In one aspect, the method determines a gain control signal and linearly varies the gain of the optical amplifier in accordance with a gain value established in one or more gain setting circuits resident in the input arm circuit and/or output arm circuit. In one preferred embodiment, the gain value is determined by a balanced settings between a first gain setting circuit in the input arm circuit and a second gain setting circuit in the output arm circuit.

Dynamic ASE correction, determined by actual operating temperature, input signal conditions, and/or desired optical amplifier gain, as well as transient correction, determined in relation to input optical signal state, may be also incorporated in the definition of a gain control signal.

The present invention may be readily applied to multistage optical amplifiers. That is, the gain control for multiple gain stages, (optionally) together with variable attenuator control, may be used to effectively suppress gain transients and compensate for gain tilt. Multiple feedback units may be applied to the multiple gain stages to achieve fully independent control of the gain stages, or a single feedback unit may be used to derive gain control signals for multiple gain stages.

### BRIEF DESCRIPTION OF THE DRAWINGS

Pedagogical examples of the present invention will be described in detail hereafter with reference to the accompanying drawings, in which:

FIG. 1 illustrates a conventional gain control system for an optical amplifier;

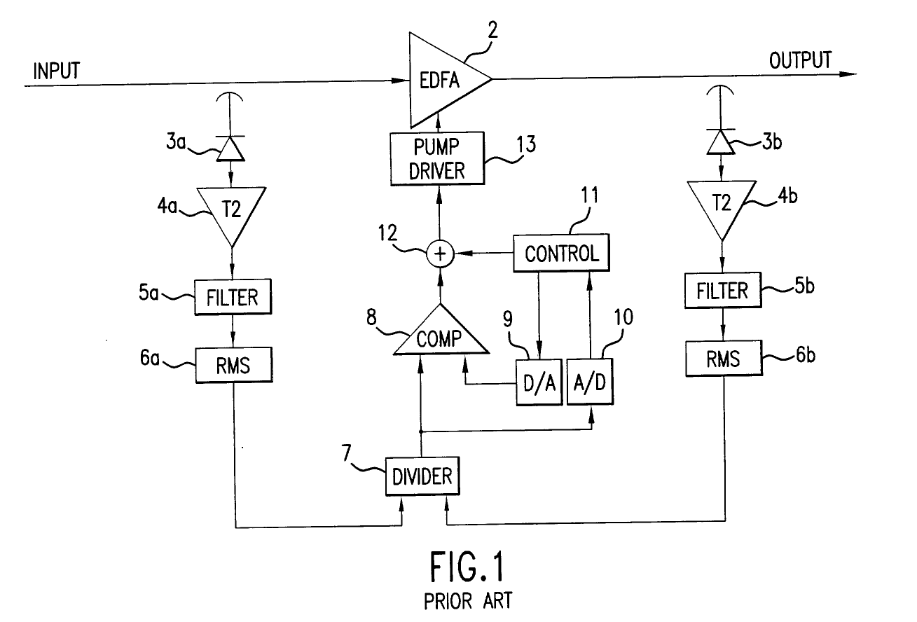

FIG. 2. illustrates a gain control system consistent with the present invention;

FIG. 3 is an embodiment of the present invention adapted to a multi-stage optical amplifier and incorporates a separate feedback unit for each gain stage of the amplifier;

FIG. 4 is another embodiment of the present invention further adapted to a multi-stage optical amplifier that uses a feed-forward unit with a first gain stage of the amplifier;

FIG. 5 is yet another embodiment of the present invention adapted to a multi-stage optical amplifier and uses a single feedback unit to drive dual V-to-I scaling units that subsequently drive respective gain stages of the amplifier;

FIG. 6 is still another embodiment of the present invention adapted to a multi-stage optical amplifier and uses a single feedback unit, a single laser diode, and an optical splitter to drive respective gain stages of the amplifier; and

FIG. 7 illustrates and exemplary two-stage Erbium-doped fiber amplifier (EDFA) having a mid-stage, variable attenuator operated in conjunction with the gain control method of the present invention to yield an accurately shaped gain profile.

### DETAILED DESCRIPTION OF THE PREFERRED EMBODIMENT(S)

The invention will now be explained using several presently preferred embodiments. These embodiment are given by way of teaching example and do not fully exhaust the scope of the invention which is defined by the claims which follow.

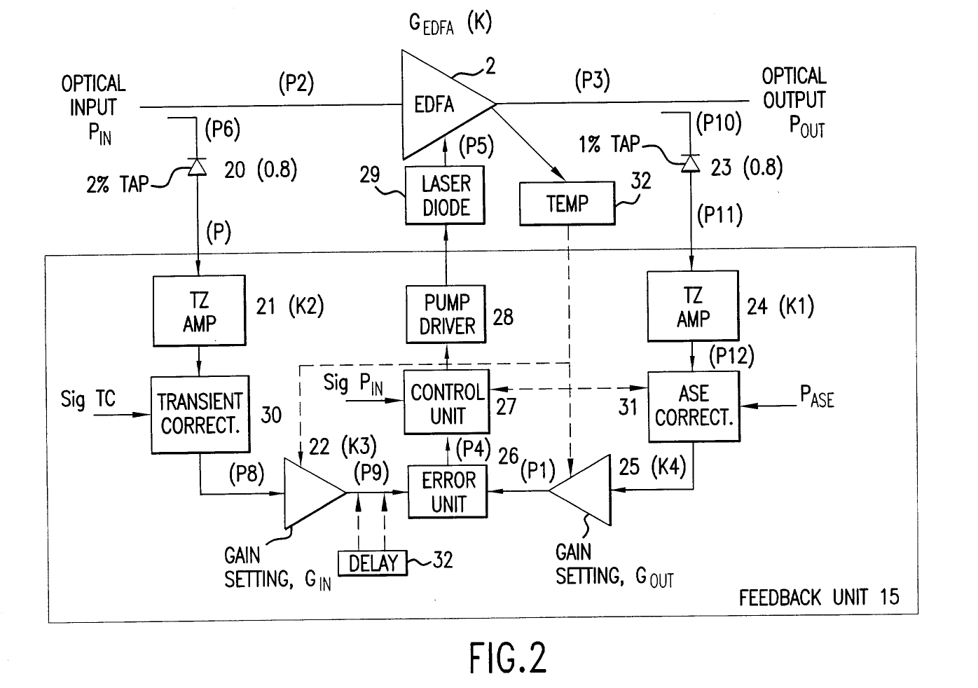

Turning to a first aspect of the present invention, a feedback unit 15 is illustrated in FIG. 2. In FIG. 2, an optical amplifier, preferably an Erbium-doped fiber amplifier (EDFA) 2 receives an input optical signal having a power level of P_{IN}. This input optical signal is amplified in EDFA 2 to yield an output optical signal having a power level Pₒᵤₜ.

Using any one of a number of conventional techniques, including the use of a splitting coupler, a portion of the optical input signal is tapped (98%/2%) and converted into an electrical input signal by photo-detector (PIN) 20. The input electrical signal is applied to an optional trans-impedance (TZ) amplifier 21 that converts the signal into a voltage representing the optical power at the input of PIN 20. Thus, when used, TZ amplifier 21 is a linear, analog device that suitably scales the input electrical signal produced at the output of PIN 20 into an input reference voltage. From TZ amplifier 21, the input reference voltage is applied to a first variable gain setting circuit 22. (The optional transient correction circuit 30 shown in FIG. 2 is discussed later). PIN 20, TZ amplifier 21 and first gain setting circuit 22 form the input arm circuit in this specific example.

The output arm circuit comprises analogous components, including PIN 23, TZ amplifier 24 and second variable gain setting circuit 25. Of particular note, either one of gain setting circuits 22 and 25 might be omitted from either the input arm circuit or the output arm circuit. Gain setting circuits 22 and 25 may be implemented using, for example, (1) a variable gain operational amplifier, (2) an operational amplifier having its gain varied by an external resistive potentiometer, (3) a potentiometer based voltage divider followed by one or more amplification stage(s), or (4) conventional circuits adapted to vary electrical gain. Where a single gain setting circuit exists in either feedback arm, this circuit directly defines the gain of EDFA 2 as explained below. However, as presently preferred, a first gain setting circuit is placed in the input arm circuit and a second gain setting circuit is placed in the output arm circuit. Accordingly, the gain of EDFA 2 is defined by the variable gain setting between the first and second gain setting circuits (22, 25). A fully balanced gain setting between the first and second gain setting circuits may well provide optimal results.

An Amplified Spontaneous Emissions (ASE) correction circuit 31 is placed in either the input arm circuit or the output arm circuit, and preferably in the output arm circuit. Rather than account for only an optical correction portion of the ASE , as is done in conventional systems, the present invention provides an ASE correction circuit that accurately calculates ASE on the basis of the input optical power level P_{IN}, operating temperature, and/or amplifier gain setting. Moreover, ASE correction includes not only a purely optical correction, but also other corrections required to compensate for the limitation in performance of the feedback unit such as: offsets, temperature drifts, and other errors related to a specific circuit implementation. By dynamically calculating an ASE value on the basis of all significant gain-determining factors, the ASE correction circuit may modify either the input reference signal (by adding in an appropriate ASE value) or the output reference signal (by subtracting out an appropriate ASE value). In either event, the ultimate gain control signal applied to EDFA 2 properly accounts for ASE as dynamically determined according to actual operating conditions.

Optionally, an operating temperature detection circuit 32 may be incorporated in a gain control system designed according to the present invention. As already noted, the actual operating temperature of EFDA 2 is highly relevant to an accurate ASE calculation and actual settings of gain settings circuits. An appropriate temperature signal may be applied directly to ASE correction circuit 31, gain settings circuits 22 and/or 25, control unit 27, or a separate external microprocessor (not shown). Operating temperature may also be relevant to the performance of other elements in the input arm circuit and output arm circuit. Where operating drift as a function of temperature is a concern for one or more components in the feedback arms, an external microprocessor (not shown) may periodically (or upon event detection) recalibrate and/or reset such components in relation to the actual operating temperature.

As shown in FIG. 2, the ASE correction circuit 31 may comprise a simple subtraction circuit receiving an output reference voltage from TZ amplifier 24 and subtracting a calculated ASE power value (P_{ASE}) from the output reference voltage to properly account for the ASE portion of the optical output signal P_{OUT} and other corrections previously discussed. The ASE power value may be calculated by a separate microprocessor (not shown in FIG. 2) running outside either feedback arm of the optical amplifier gain control system. ASE correction circuit 31 may receive inputs indicating optical input power P_{IN}, operating temperature, optical amplifier gain setting, and/or corrections required to compensate for offsets, temperature drifts, and other errors related to a specific circuit implementation, and internally determine an appropriate ASE correction value. The ASE correction value determination may be accomplished by means of a look-up table, or by analog circuitry.

In the working example shown in FIG. 2, it is assumed that ASE correction circuit 31 is placed in the output arm circuit and that first and second gain setting circuits are placed respectively in the input arm circuit and the output arm circuit. With these assumptions, a method by which the gain of EDFA 2 may be accurately set and readily maintained will be explained within the context of the present invention. In effect, the input reference signal and output reference signal will zero-out in error unit 26 (preferably a simple subtraction circuit), when the desired gain of EDFA 2 (G_{EDFA} or K) is equal to the gain established by first gain setting circuit 22 (G_{IN} or K3) and second gain setting circuits 25 (G_{OUT} or K4).

The following equation further illustrates this point:

0=[(P_{OUT}−P_{ASE})*G_{OUT}]−(P_{IN}*G_{IN})

where, P_{OUT} is the power of the optical signal output by the optical amplifier, P_{ASE} is the value of the ASE correction value calculated by ASE correction circuit 31, G_{OUT} is the gain of the second gain setting circuit 25, P_{IN} is the power of the optical signal input to the optical amplifier, and G_{IN} is the gain of the first gain setting circuit 22.

These relationships allow for an infinite number of gain setting options. Three possible options are, however, particularly germane: (1) where G_{IN} is set to unity (1), G_{OUT} will be 1/G_{EDFA}; (2) where G_{OUT} is set to unity (1), G_{IN} will be G_{EDFA}; and (3) where, for the balanced case, G_{IN} is set to the square root of G_{EDFA}, G_{OUT} is set to 1 over the square root of G_{EDFA}.

The balanced case is presently preferred since it typically offers the best combination of feedback speed and low noise. That is, gain is typically applied to the input reference voltage apparent in the input arm circuit, whereas attenuation (negative gain) is applied to the output reference voltage apparent in the output arm circuit. “Gaining-up” a relatively small reference voltage in the input arm circuit is an effective way of adjusting gain in the control system, but at certain limits too much gain slows the feedback circuit response time. Similarly, attenuating a relatively large reference voltage in the output arm circuit is an effective way of adjusting gain in the control system, but at certain limits too much attenuation introduces noise into the feedback circuit. Thus, a balanced approach, including a fully balanced approach to gain definition will preclude extremes in the gain and/or attenuation necessarily applied by the first and/or second gain setting circuits.

The approach taken by the present invention allows for well understood signal relationships and highly accurate gain definitions by the gain setting circuit(s). For example, returning to FIG. 2, it is assumed that gain (K) for EDFA 2 should be defined entirely by the gain (K3) of first gain setting circuit 22, and thus gain (K4) for second gain setting circuit 25 should be 1. In other words, the design goal is K=K3.

Looking in FIG. 2 at the (power factors) associated with circuit elements, we see that in the output arm circuit:

P2=(0.98) P_{IN}

P3=(K) P2+ASE

P10=(0.01) P3

P11=(0.8) P10

P12=(K1) P11=[(0.00784) (K) (K1) P_{IN}]+[(0.008) (K1) ASE]

P1=P12−V_{ASE}

Thus, if V_{ASE} is equal to (0.008) (K1) ASE, then P1 is equal to (0.00784) (K) (K1) P_{IN}.

In the input arm circuit:

P6=(0.02) P_{IN}

P7=(0.8) P6

P8=(K2) P7

P9=(K3) P8=(0.016) (K2) (K3) P_{IN}

In error unit 26, P4=P9−P1, and where P4 is zero, then P9=P1, or

(0.016)(K2)(K3)P_{IN}=(0.00784)(K)(K1)P_{IN}

From this relationship we see that,

K3=[(0.049)(K)(K1)]/(K2)

If we let K2=(0.049) (K1), then K will equal K3. That is, the gain of EDFA 2 will be directly defined by the gain established in the first gain setting circuit 22. Gain K3 may be equal to K or it may be scaled in relation to K when, for example, TZ amplifiers gains are not related as K2=(0.049) (K1). Thus, the gain K for EFDA 2 may be linearly defined by the gain K3 of the first gain setting circuit 22. No complex non-linear functions are required, and the gain of the optical amplifier in the present invention can be simply and precisely controlled by linear analog circuitry. Control system response time is improved accordingly.

Again returning to FIG. 2, error unit 26 receives the input reference signal from first gain setting circuit 22 and the output reference signal from second gain setting circuit 25. Error unit 26 is preferably a simple subtraction circuit. The result of subtracting these two reference signals is an error signal applied to control unit 27.

Control unit 27 may incorporate, at the system designer's choice, a proportional control circuit, an integrator circuit, and/or a differentiator circuit. Thus, parallel proportional, integration, and/or differentiation control signals added with appropriate weights to form the error signal in order to provide the desired control signal to pump driver 28, such that EDFA 2 will respond acceptably to required changes in pump power. The proportional and integral control aspects of control unit 27 largely define the overall feedback control loop. In one approach, the temporal response of the overall feedback loop is preferably matched to the open loop gain of the optical amplifier so that the overall feedback control is appropriately damped. The feedback control must be stable, so that oscillations are avoided, but should not be over-damped such that the response time is prolonged beyond the pint where required changes in pump power are missed.

The use of proportional/integral/differential (PID) controllers in conventional gain control systems for optical amplifiers is known. However, within such conventional implementations the parameters of the PID controller are fixed upon initialization of the control system.

In contrast, the present invention recognizes that proportional control should more properly vary with the power level of the input optical signal P_{IN}, optical gain setting and other system parameters. Accordingly, the present invention provides variable (or adaptive) proportional gain in relation to input power P_{IN} and/or optical gain setting. Those of ordinary skill in the art will understand several ways in which the parameters of conventional PID control circuit may be modified to account for changes in a input power reference signal (or derived digital value) (Sig P_{IN}) indicative of changes in P_{IN}, and/or changes of the optical gain setting.

The input power reference signal, as applied to control unit 27, may also indicate a “low input signal” condition in which the input optical power falls below some predetermined threshold. Such a condition may arise following a cut in the optical fiber cable. In response to a low input signal condition, the control unit may minimize or turn-OFF current to laser diode 29 or set the current to a predetermined value.

Adaptive control is extended in the present invention to the integrator and differentiator. Here, the integrator and/or differentiator circuits are switched IN and OUT of the control unit functionality in response to certain conditions detected in the optical communication system. For example, an integration time constant associated with the integrator circuit may be changed in response to changes in Sig P_{IN}. Alternatively, the integrator circuit may be switched OUT (i.e., be disabled) when large swings in Sig P_{IN} are detected, or switched IN (i.e., become operable) when Sig P_{IN} is relatively constant over a selected period of time. Similarly, the differentiator circuit may be switched IN or OUT of the control unit functionality in relation to changes in Sig P_{IN}. Also its differentiation constant may be changed in response to changes in Sig P_{IN} and the strength of the differentiation signal may be different for rise and for fall of Sig P_{IN}.

In the foregoing example, the proportional, integration, and differentiation functions are described as being performed in a single control unit. One of ordinary skill in art will appreciate, however, each of these functions may be separately applied in a separate circuit, perhaps located elsewhere in the control system. For example, the differentiator circuit may well be better placed as a separate signal circuit conditioning optical input signal in the input arm circuit. In particular, the differentiator may drive a Sig_{TC} (discussed below) of a transient correction unit 30.

The exemplary feedback unit 15 shown in FIG. 2 may be further (and optionally) modified to incorporate a transient correction circuit 30 in the input arm circuit. As WDM communication systems are stressed to handle more and more, rapidly adding/dropping channels, the possibility of encountering truly exceptional system conditions rises proportionally. Transient correction circuit 30 addresses such conditions. In one embodiment, placement of the transient correction circuit 30 in the input arm circuit mirrors (symmetrically) the presence of ASE correction circuit 31 in the output arm circuit. In another possible embodiment (not shown), transient correction circuit 30 and ASE correction circuit 31 are combined and implemented in the input or the output arms of the circuit.

Transient correction circuit 30 may be responsive to a transient indication signal (Sig_{TC}) received from a differentiation of the input signal or a separate microprocessor or control element (not shown), or may internally determine its functional operation in response to detected changes in P_{IN}. When operating in response to a detection of a dramatically large dynamic change in the power level of the input optical signal, transient correction circuit 30 provides a feed-forward pulse boost to the input reference voltage. This response significantly improves operation of the feedback loop during the first few microseconds following the changes in the power level of the input optical signal.

As yet another option to the feedback unit 15 shown in FIG. 2, a delay line 32 may be placed in the input arm circuit and/or the output arm circuit. Again, as WDM communication systems are stressed by rapidly changing channel loads, the synchronized monitoring (or sampling, or latching, or subtraction in an error unit circuit) of the input and output reference signals becomes important. In other words, potentially rapid and dramatic gain transients in the input optical signal resulting in equally rapid changes of optical signal at the amplifier output require a synchronized timing of the input and output arms (P1) and (P9) at the input of the Error Unit (26). Thus, a serious skew between signal delays through the input arm circuit and output arm circuit will result in an input reference signal and output reference signal unrelated in time, or unrelated to current system conditions.

Thus, the benefit of feedback arms formed from high-speed, linear, analog components is further highlighted. Additional steps to ensure signal synchronization at the error unit may also be necessary. The delay line 32 (programmable or fixed) may be used to “synch” input and output reference signals at the error unit. Alternatively, signal delay through existing circuit elements might be altered to substantially equalize signal delay through the input arm circuit and the output arm circuit.

Central to the issue of synchronizing the input and output reference signals at the error unit, the gain control system designer must understand the delay necessarily arising in the output reference signal due to the propagation time of the optical signal through the optical amplifier which includes one or more multi-meter segments of Erbium-doped fiber. Propagation times will vary but will usually exceed 200 nanoseconds. In conventional gain control systems, such optical signal propagation delays are irrelevant since feedback response times are measured in milliseconds. However, this may not be the case for the present invention which is characterized by very fast response times.

Taking all relevant factors into consideration, the overall feedback loop will be designed with an appropriate speed. The present invention enables overall open feedback loop speeds, as measured from photo-detector to laser diode output, including rise-times and delays, well below ten microseconds, and preferably below one microsecond.

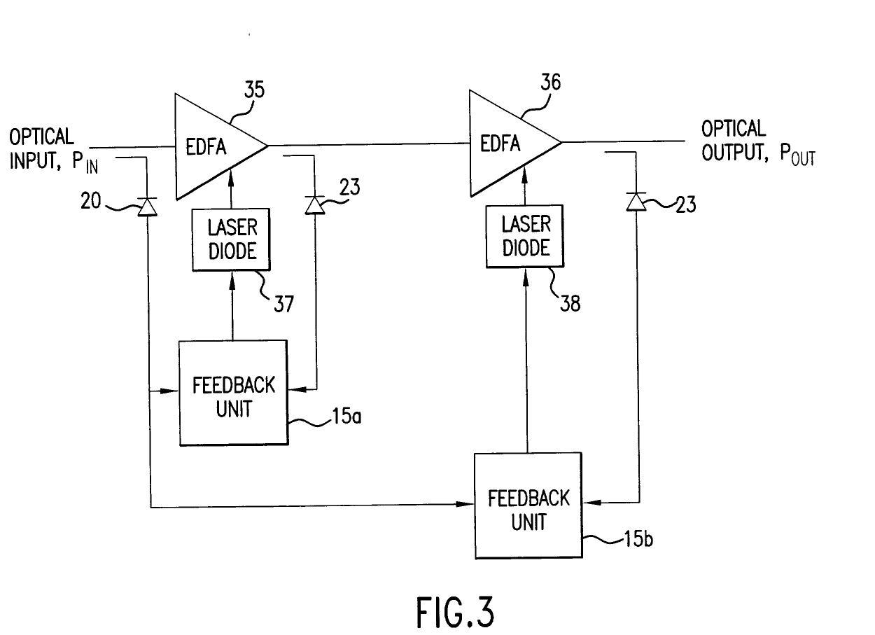

The gain system of the present invention may be readily applied to optical amplifiers having a plurality of gain stages. Such multi-stage optical amplifiers are common. FIG. 3 shows one exemplary application of the present invention to a multi-stage optical amplifier. In this example, a first gain stage 35 receives an input optical signal P_{IN}. Photo-detector 20 converts a tapped portion of the input optical signal and provides it through an input arm circuit, as described above, to feedback unit 15A and 15B.

Once amplified in first gain stage 35, the optical signal may traverse a number of intervening elements, such as filters, add/drop multiplexers, service channel insertion/extraction couplers, attenuators, isolators, etc., before entering a second gain stage 36. Respective output arm circuits are provided following each of the first and second gain stages, and apply respective output reference signals to feedback units 15A and 15B.

In accordance with the examples given above, feedback unit 15A provides a first gain control signal to laser diode 37 and feedback unit 15B provides a second gain control signal to laser diode 38. In this manner, each gain stage of a multi-stage optical amplifier may be subjected to full (i.e., independent) gain control, as provided by the present invention. Alternatively, a single feedback unit might be used with multiplexed output reference signals from first and second gain stages.

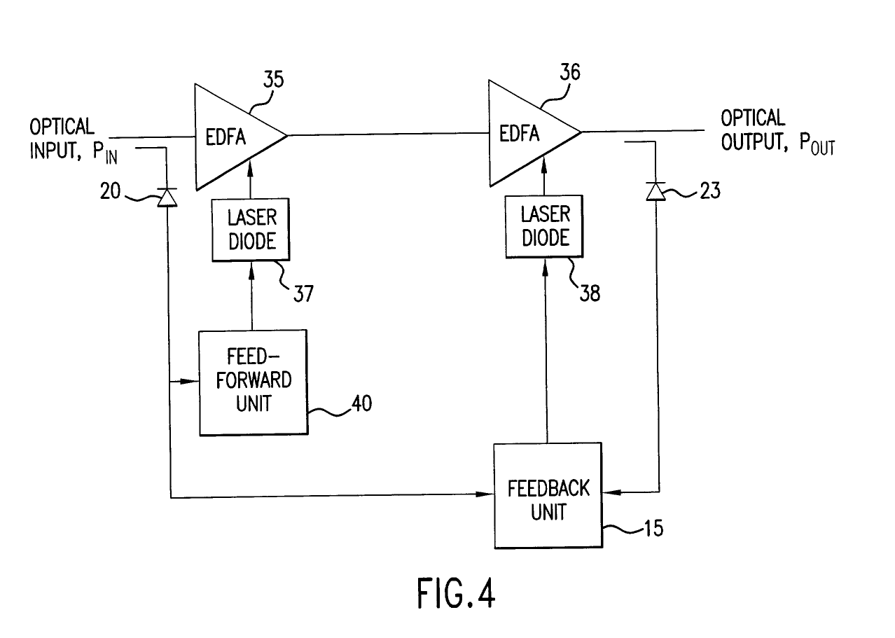

FIG. 4 shows another, less costly modification of the multi-stage gain control arrangement taught in FIG. 3. Here, a single feedback unit 15 provides a gain control signal to laser diode 38 driving the second gain stage 36. Such “full function” control allows the second gain stage to be driven very accurately over a well defined range of control. This range of control is largely a function of the optical input applied to the amplifier. In order to reasonably minimize the control range required for the second gain stage, the optical signal passed from the first gain stage should arrive within a corresponding range of optical power levels.

Since this second gain stage optical input requirement is relatively gross, there may be no need to provide full feedback control to the first gain stage. Rather, a rough correction may be had by means of a feed-forward unit 40. Feed-forward unit 40 may be as simple as a look-up table defining a drive current for laser diode 37 in accordance with a detected value for an optical input power level P_{IN} The values in the look-up table may be dependent on the over all gain setting of the optical amplifier, temperature and the rate of change of the optical input. Such coarse signal correction may be sufficient given the enhanced capabilities of the second gain stage. Alternatively, the feed-forward unit 40 may include more sophisticated circuits such as a proportional control, differentiator, and/or discriminator circuit(s).

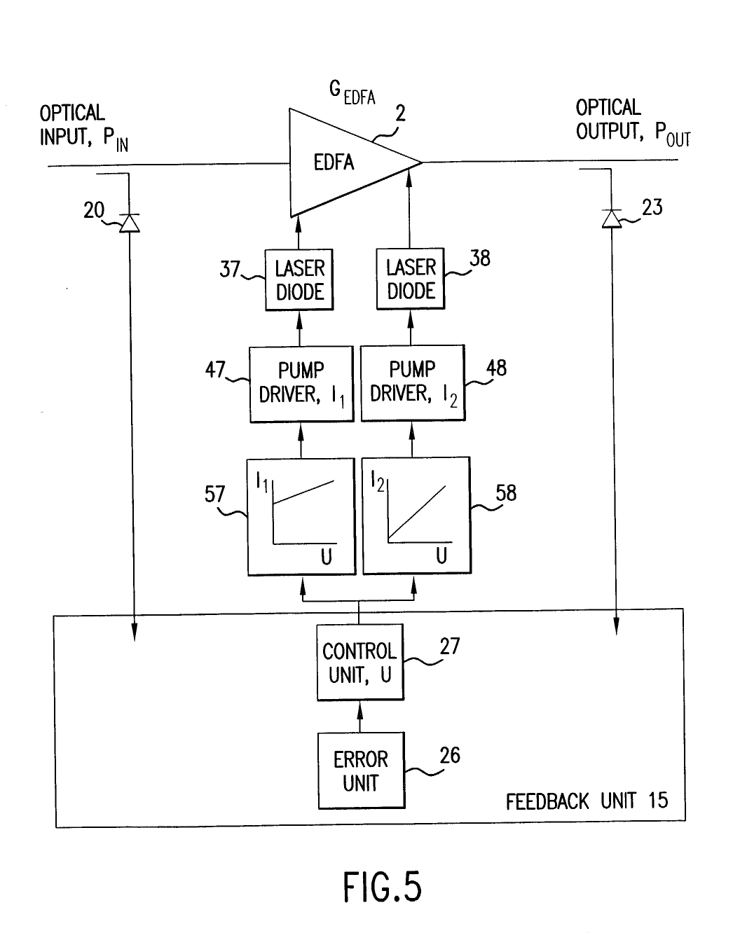

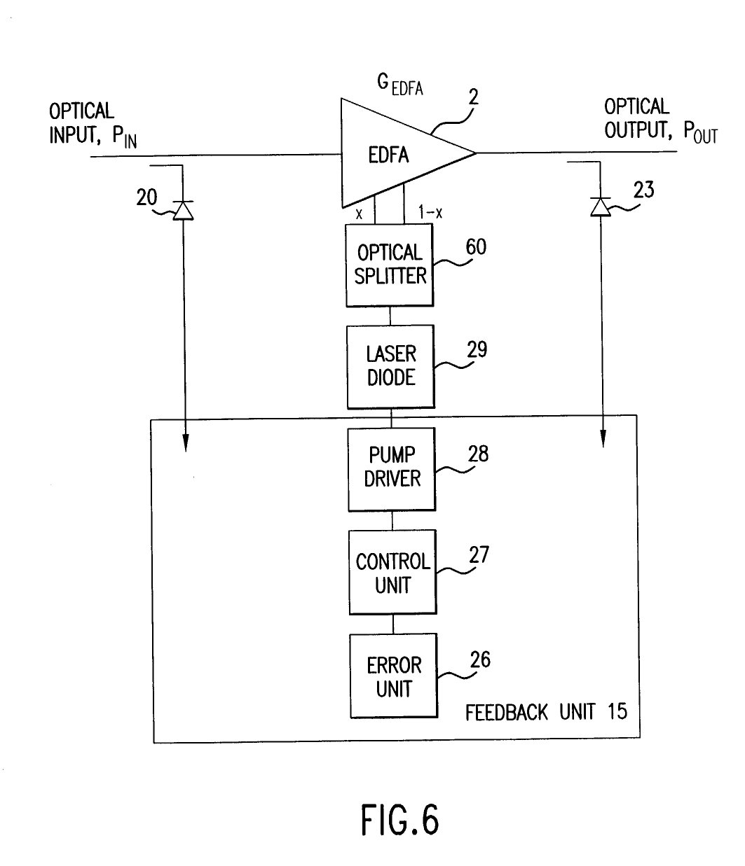

As shown in FIGS. 5 and 6, multi-stage gain control in an optical amplifier may be readily achieved using a single feedback unit of the nature previously described.

In FIG. 5, the gain control signal generated by control unit 27 is applied to a plurality of voltage-to-current (V-to-I) scaling units (57, 58). Each V-to-I scaling unit defines a function, preferably a non-linear function, relating the gain control signal voltage to a pump driver current, respectively applied to a pump driver (47, 48). The pump drivers thereafter respectively determine the action of pump laser diodes (37, 38).

This approach to gain control offers several advantages. The V-to-I scaling units may define very different linear or non-linear functions. For example, it is usually desirable to “gain-up” the optical signal more in the first gain stage rather than the second gain stage. Such uneven gain application provides an output optical signal having relatively less noise. Accordingly, the first function has some threshold offset reflecting the requirement additional first stage gain.

This approach to gain control allows the desired overall gain to be spread between multiple gain stages. (Two stages have been shown in the examples, but more than two gain stages are very possible). Uneven (i.e., not 50%/50%) distribution of gain as between two gain stages allows the designer to better compensate for gain transients and adjust for gain tilt.

Finally, this approach to gain control preserves dynamic range in both gain stages. Better finite gain control may be achieved.

FIG. 6 offers yet another example of cost effective feedback control to a multi-stage optical amplifier. Here, a gain control signal from control unit 27 is applied to pump driver 28 which drives laser diode 29. However, the output of laser diode 29 is applied to an optical splitter 60 which divides the optical pump signal in proportions X and 1-X before applying these respective optical signals to a first and second gain stage within EDFA 2. This approach eliminates a laser diode from the two stage design.

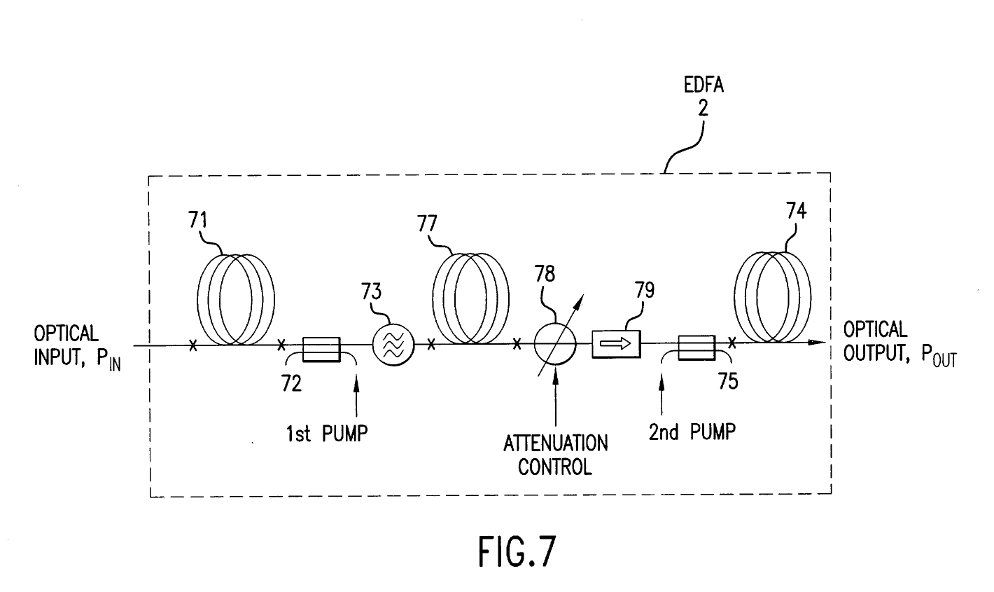

The practical application and associated benefits of the present invention will be further appreciated by considering another example drawn to a specific optical amplifier design. This design is shown in FIG. 7. In FIG. 7, an optical input signal P_{IN} is applied to a first segment of Erbium doped fiber 71. First stage gain of the optical signal is determined by the first pump laser input applied to coupled 72. The first pump laser (laser diode or analogous device) may be controlled according to the dictates of the present invention.

Following first stage amplification, the optical signal may pass through any number of optional “mid-span” elements, including in this particular example, a fixed gain flattening filter 73, a segment of non-pumped saturable fiber 77, variable attenuator 78 and optical isolator 79. The combination of gain flattening filter 73 and non-pumped saturable fiber 77 have a beneficial and well understood effect on the “flatness” of the amplified optical signal spectrum. U.S. Pat. No. 5,530,584 describes this effect and is hereby incorporated by reference.

Second stage amplification is provided by a second segment of Erbium-doped fiber 74 and a second pump laser connected via coupler 75.

Variable attenuator 78 may be dynamically controlled by, for example, the control unit described above in conjunction with the first and second gain stages to provide a particularly advantageous gain profile. That is, the gain profile across the entire spectrum of optical wavelengths amplified by the optical amplifier may be dynamically and accurately shaped in response to changes in the power level of the optical input signal, the operating temperature of the optical amplifier, and the desired overall (or nominal) optical gain setting.

As is well understood, gain flatness is a function of these factors, and as has been described, the present invention provides accurate and dynamic control of the first and second gain stages across a compound of ranges for these factors. Adding the dynamic effect of variable, mid-span attenuation, allows the gain control system of the present invention to carefully shape the gain spectrum for a desired gain setting while taking into account real-time changes in input power and temperature.

What is claimed is:

1. A gain control system for an optical amplifier, the optical amplifier receiving an input optical signal and amplifying the input optical signal to generate an output optical signal, the gain control system comprising:
an input arm circuit generating an electrical input reference signal, the input reference signal indicating an input power level for the input optical signal;
an output arm circuit generating an electrical output reference signal, the output reference signal indicating an output power level for the output optical signal;
an error circuit receiving the input reference signal and the output reference signal and generating an error signal in accordance with a difference between the input reference signal and the output reference signal; and,
a control circuit generating a gain control signal for the optical amplifier in responsive to the error signal;
wherein the input arm circuit, the output arm circuit, and the error circuit consist essentially of linear, analog circuitry.

2. The gain control system of claim 1, wherein the input arm circuit further comprises:
a first gain setting circuit, wherein gain of the optical amplifier is directly defined by a gain value established in the first gain setting circuit.

3. The gain control system of claim 2, wherein the gain of the optical amplifier varies linearly with variation in the gain value established in the first gain setting circuit.

4. The gain control system of claim 1, wherein the input arm circuit further comprises a first gain setting circuit, and the output arm circuit further comprises a second gain setting circuit; and,
wherein gain of the optical amplifier is defined by variable gain settings in the first gain setting circuit and the second gain setting circuit.

5. The gain control system of claim 4, wherein gain of the optical amplifier is defined by a balanced gain settings between the first gain setting circuit and the second gain setting circuit

6. The gain control system of claim 1, wherein the output arm circuit further comprises an amplified spontaneous emissions (ASE) correction circuit modifying the output reference signal in relation to a calculated ASE value.

7. The gain control system of claim 6, wherein the ASE value is calculated in relation to at least one factor selected from a group of factors consisting of; operating temperature, optical amplifier gain, power level of the input optical signal, power level of the output optical signal, and error values or signals defined in relation to a particular control hardware implementation.

8. The gain control system of claim 6, further comprising a temperature measurement circuit adapted to measure the operating temperature of the optical amplifier and generate a temperature signal indicative of the temperature;
wherein the ASE correction circuit receives the temperature signal and calculate the ASE value in relation to the temperature signal.

9. The gain control system of claim 1, wherein the error circuit is a subtraction circuit.

10. The gain control system of claim 1, wherein the control circuit comprises a proportional control circuit applying a proportional weighting to the error signal;
wherein the proportional weighting varies with the power level of the input optical signal.

11. The gain control system of claim 10, wherein the control circuit further comprises an integrator circuit applying an integration weighting to the error signal;
wherein the integration circuit is adapted to be functionally switched IN and OUT of the control circuit operation in response to changes in the input optical signal.

12. A gain control system for an optical amplifier, the optical amplifier receiving an input optical signal and amplifying the input optical signal to generate an output optical signal, the gain control system comprising:
an input arm circuit generating an electrical input reference signal, the input reference signal indicating an input power level for the input optical signal:
an output arm circuit generating an electrical output reference signal, the output reference signal indicating an output power level for the output optical signal;
an error circuit receiving the input reference signal and the output reference signal and generating an error signal in accordance with a difference between the input reference signal and the output reference signal; and,
a control circuit generating a gain control signal for the optical amplifier in responsive to the error signal;
wherein the input arm circuit comprises:
a gain setting circuit adjusting the level of the input reference voltage in accordance with a gain value to define the input reference signal, wherein the gain value directly determines the gain of the optical amplifier.

13. A gain control system for an optical amplifier, the optical amplifier receiving an input optical signal and amplifying the input optical signal to generate an output optical signal, the gain control system comprising:
an input arm circuit generating an electrical input reference signal, the input reference signal indicating an input power level for the input optical signal:
an output arm circuit generating an electrical output reference signal, the output reference signal indicating an output power level for the output optical signal;
an error circuit receiving the input reference signal and the output reference signal and generating an error signal in accordance with a difference between the input reference signal and the output reference signal; and,
a control circuit generating a gain control signal for the optical amplifier in responsive to the error signal;
wherein the output arm circuit comprises:
a gain setting circuit adjusting the level of the output reference voltage in accordance with a gain value to define the output reference signal, wherein the gain value directly determines the gain of the optical amplifier.

14. A gain control system for an optical amplifier, the optical amplifier receiving an input optical signal and amplifying the input optical signal to generate an output optical signal, the gain control system comprising:
an input arm circuit generating an electrical input reference signal, the input reference signal indicating an input power level for the input optical signal:
an output arm circuit generating an electrical output reference signal, the output reference signal indicating an output power level for the output optical signal;
an error circuit receiving the input reference signal and the output reference signal and generating an error signal in accordance with a difference between the input reference signal and the output reference signal; and,
a control circuit generating a gain control signal for the optical amplifier in responsive to the error signal;
wherein the input arm circuit comprises a first gain setting circuit adjusting the level of the input reference voltage in accordance with a first gain value to define the input reference signal;
wherein the output arm circuit comprises a second gain setting circuit adjusting the level of the output reference voltage in accordance with a second gain value to define the output reference signal; and,
wherein the gain of the optical amplifier is defined by the variable setting of the first and second gain values.

15. The gain control system of claim 14, wherein gain of the optical amplifier is defined by a balanced setting of the first and second gain values.

16. A gain control system for an optical amplifier, the optical amplifier receiving an input optical signal and amplifying the input optical signal to generate an output optical signal, the gain control system comprising:
an input arm circuit generating an electrical input reference signal, the input reference signal indicating an input power level for the input optical signal:
an output arm circuit generating an electrical output reference signal, the output reference signal indicating an output power level for the output optical signal;
an error circuit receiving the input reference signal and the output reference signal and generating an error signal in accordance with a difference between the input reference signal and the output reference signal; and,
a control circuit generating a gain control signal for the optical amplifier in responsive to the error signal;
wherein the input arm circuit comprises:
a transient correction circuit applying feed-forward boosting pulses to the input reference signal in response to detected changes in the input optical signal.

17. A gain control system for an optical amplifier, the optical amplifier receiving an input optical signal and amplifying the input optical signal to generate an output optical signal, the gain control system comprising:
an input arm circuit generating an electrical input reference signal, the input reference signal indicating an input power level for the input optical signal:
an output arm circuit generating an electrical output reference signal, the output reference signal indicating an output power level for the output optical signal;
an error circuit receiving the input reference signal and the output reference signal and generating an error signal in accordance with a difference between the input reference signal and the output reference signal; and,
a control circuit generating a gain control signal for the optical amplifier in responsive to the error signal;
wherein the input arm circuit comprises:
a delay line properly sized to synchronize arrival of the input reference signal with the output reference signal at the error circuit.

18. A method of controlling optical amplifier gain, the optical amplifier receiving an input optical signal and amplifying the input optical signal to generate an output optical signal, and the method comprising:
in an input arm circuit, forming an input reference signal indicative of a power level for the input optical signal;
in an output arm circuit, forming an output reference signal indicative of a power level for the output optical signal;
defining a gain constant in at least one gain setting circuit, wherein the at least one gain setting circuit forms a portion of at least one of the input arm circuit and output arm circuit;
wherein the optical amplifier gain varies linearly with the gain constant.

19. The method of claim 18, wherein the at least one gain setting circuit comprises a single gain setting circuit in either the input arm circuit or the output arm circuit; and,
wherein the single gain setting circuit electronically determined the gain constant.

20. The method of claim 18, wherein the at least one gain setting circuit comprises:
a first gain setting circuit in the input arm circuit applying a first gain constant to the input reference signal and a second gain setting circuit in the output arm circuit applying a second gain constant to the output reference signal;
wherein the gain constant is a product of the first and second gain constants.

21. The method of claim 20, wherein the gain constant is the product of a balanced setting between the first and second gain constants.

22. The method of claim 21, wherein the input arm circuit and output arm circuit are formed from wholly linear, analog devices.

23. The method of claim 21, wherein the first gain constant is equal to the square root of a value for the optical amplifier gain, and the second gain constant is equal to the reciprocal of the square root of a value for the optical amplifier gain.

24. A method of forming a gain control signal for an optical amplifier having a desired gain, the optical amplifier receiving an input optical signal and amplifying the input optical signal to generate an output optical signal, and the method comprising:
in an input arm circuit, forming an input reference signal indicative of a power level for the input optical signal;
in an output arm circuit, forming an output reference signal indicative of a power level for the output optical signal;
defining a gain constant in at least one gain setting circuit, wherein the at least one gain setting circuit forms a portion of at least one of the input arm circuit and output arm circuit, and wherein the optical amplifier gain varies linearly with the gain constant;
defining an Amplified Spontaneous Emissions (ASE) power value in relation to at least one factor selected from a group of factors consisting of temperature, a power level for the input optical signal, and the desired gain;
performing ASE correction by modifying either the input reference signal or the output reference signal in accordance with the ASE power value; and,
following ASE correction, defining the gain control signal in relation to an error signal defined by a difference between the input reference signal and the output reference signal.

25. The method of claim 24, further comprising:
further defining the gain control signal by applying a proportional weighting to the error signal, wherein the proportional weighting varies with the power level of the input optical signal.

26. The method of claim 25, further comprising:
further defining the gain control signal by selectively applying an integration weighting to the error signal in response to variations in the power level of the input optical signal.

27. The method of claim 24, wherein ASE correction comprises modifying the output reference signal in accordance with the ASE power value; and the method further comprises:
before the step of defining the gain control signal, performing transient correction by modifying the input reference signal in response to power level transients in the input optical signal.

28. The method of claim 24 further comprising:
delaying the input reference signal before the step of defining the gain control signal, such that input reference signal and the output reference signal defining the error signal are synchronously related to the input optical signal.

29. A multistage optical amplifier receiving an input optical signal and amplifying the input optical signal to generate an output optical signal, the multistage optical amplifier comprising a first gain stage and a second gain stage, where gain in the second gain stage is controlled by a first feedback unit, the first feedback unit comprising:
a first input arm circuit generating a first input reference signal, the first input reference signal indicating a power level for an optical signal output by the first gain stage;
a first output arm circuit generating a first output reference signal, the first output reference signal indicating a power level for the output optical signal;
a first error circuit receiving the first input reference signal and the first output reference signal and generating a first error signal in accordance with a difference between the first input reference signal and the first output reference signal;
a control circuit generating a first gain control signal in responsive to the first error signal; and,
at least one gain setting circuit modifying either the first input reference signal or the first output reference signal in accordance with a first gain value, wherein gain for the second gain stage varies linearly with first gain value.

30. The multistage optical amplifier of claim 29, further comprising
a second feedback unit controlling gain in the first gain stage, the second feedback unit comprising:
a second input arm circuit generating a second input reference signal, the second input reference signal indicating a power level for the input optical signal;
a second output arm circuit generating a second output reference signal, the second output reference signal indicating a power level for the signal output by the first gain stage;
a second error circuit receiving the second input reference signal and the second output reference signal and generating a second error signal in accordance with a difference between the second input reference signal and the second output reference signal;
a control circuit generating a second gain control signal in responsive to the second error signal; and,
at least one gain setting circuit modifying either the second input reference signal or the second output reference signal in accordance with a second gain value, wherein gain for the first gain stage varies linearly with second gain value.

31. The multistage optical amplifier of claim 29, further comprising:
a feed-forward unit controlling gain in the first gain stage in response to a power level in the input optical signal.

32. A multistage optical amplifier receiving an input optical signal and amplifying the input optical signal to generate an output optical signal, the multistage optical amplifier comprising:
a first gain stage having a first gain and a second gain stage having a second gain; and,
a feedback unit controlling the first and second gains and comprising:
an input arm circuit generating an input reference signal, the input reference signal indicating a power level for the input optical signal;
an output arm circuit generating an output reference signal, the output reference signal indicating a power level for the output optical signal;
an error circuit receiving the input reference signal and the output reference signal and generating an error signal in accordance with a difference between the input reference signal and the output reference signal;
a control circuit generating a gain control signal in responsive to the error signal;
at least one gain setting circuit modifying either the first input reference signal or the first output reference signal in accordance with a gain value, wherein gain for the optical amplifier varies linearly with the gain value; and
first and second voltage-to-current (V-to-I) circuits, each one of the first and second V-to-I circuits receiving the gain control signal from the control circuit and respectively scaling the gain control signal in accordance with a first and second linear function;
a first pump driver receiving a first scaled gain control signal from the first V-to-I circuit and driving a first pump laser coupled to the first gain stage in response thereto; and,
a second pump driver receiving a second scaled gain control signal from the second V-to-I circuit and driving a second pump laser coupled to the second gain stage in response thereto.

33. The optical amplifier of claim 32, further comprising:
a variable attenuator placed between the first and second gain stages and adapted to adjust gain profile for the optical amplifier in conjunction with the first and second scaled gain control signal.

34. A multistage optical amplifier receiving an input optical signal and amplifying the input optical signal to generate an output optical signal, the multistage optical amplifier comprising:
a first gain stage having a first gain and a second gain stage having a second gain; and,
a feedback unit controlling the first and second gains and comprising:
an input arm circuit generating an input reference signal, the input reference signal indicating a power level for the input optical signal;
an output arm circuit generating an output reference signal, the output reference signal indicating a power level for the output optical signal;
an error circuit receiving the input reference signal and the output reference signal and generating an error signal in accordance with a difference between the input reference signal and the output reference signal;
a control circuit generating a gain control signal in responsive to the error signal;
at least one gain setting circuit modifying either the first input reference signal or the first output reference signal in accordance with a gain value, wherein gain for the optical amplifier varies linearly with the gain value; and
a pump driver receiving the gain control signal from the control circuit and driving a pump laser to produce an optical pump signal in response to the gain control signal; and,
an optical signal splitter receiving and splitting the optical pump signal into a first optical pump signal portion and second optical pump signal portion, and applying the first portion to the first gain stage and the second portion to the second gain stage.

35. The optical amplifier of claim 34, further comprising:
a variable attenuator placed between the first and second gain stages and adapted to adjust gain profile for the optical amplifier in conjunction with the first and second optical pump signal portions.

36. A gain control system for an optical amplifier, the optical amplifier receiving an input optical signal and amplifying the input optical signal to generate an output optical signal, the gain control system comprising:
an input arm circuit generating an electrical input reference signal, the input reference signal indicating an input power level for the input optical signal;
an output arm circuit generating an electrical output reference signal, the output reference signal indicating an output power level for the output optical signal;
an error circuit receiving the input reference signal and the output reference signal and generating an error signal in accordance with a difference between the input reference signal and the output reference signal; and,
a control circuit generating a gain control signal for the optical amplifier in responsive to the error signal;
wherein the input arm circuit and the output arm circuit consist essentially of linear, analog circuitry, and wherein the error circuit is implemented in software being executed by a digital signal processor.
